(19) United States
(12) Patent Application Publication
(10) Pub. No.: US 2002/0099492 A1
(43) Pub. Date: Jul. 25, 2002

(54) Fuel injection device and fuel injection control apparatus

(75) Inventors: Naoya Okawa, Obu-shi (JP); Kazuyuki Kashiwabara, Obu-shi (JP)

Correspondence Address: OLIFF & BERRIDGE, PLC, P.O. BOX 19928, ALEXANDRIA, VA, 22320, US

(73) Assignee: AISAN KOGYO KABUSHIKI KAISHA, Obu-shi (JP)

(21) Appl. No.: 09/996,782

(22) Filed: Nov. 30, 2001

(30) Foreign Application Priority Data
Dec. 4, 2000 (JP) 2000-368810

(51) Int. Cl. G05D 1/00

(52) U.S. Cl. 701/104; 701/115; 123/478

(57) ABSTRACT

A fuel injection control apparatus includes a fuel injection device 14 and an electronic control unit (ECU) 30. The fuel injection device includes a plurality of injectors 9 mounted on a delivery pipe 10, a memory 43 which stores an injection characteristic of each injector 9 provided in the pipe 10, a driving circuit 41, and others. The ECU 30 calculates a control amount, which is equivalent to an injection amount to be injected from one injector 9 each time, based on an injector standard characteristic, refers to a memory 43 to correct characteristic data of each injector 9 corresponding to the control amount, and outputs. The driving circuit 41 of the fuel injection device 14 controls each injector 9 based on the corrected control amount to individually controls the fuel injection amount of each injector 9.

### BACKGROUND OF THE INVENTION

1. Field of the Invention

The present invention relates to a fuel injection device including a plurality of injectors mounted on a delivery pipe and a fuel injection control apparatus which individually drives the injectors of the fuel injection device based on each desired control amount, thereby individually controlling a fuel injection amount to be injected from each injector.

2. Description of Related Art

Conventionally, for example, in vehicle engines, fuel injection is electronically controlled. In this kind of technique, a plurality of injectors, a pressure regulator, and others are used being mounted on a delivery pipe. In this electronically controlled fuel injection, an electronic control unit (ECU) calculates a control amount corresponding to an injection amount according to the operating condition of an engine and individually controls each injector based on the calculated control amount, thereby controlling a fuel injection amount to be injected from each injector.

The delivery pipe is used for distributing the fuel pressure-fed inside from a fuel tank, to a plurality of ports. The injectors are fit respectively in the ports of the delivery pipe. The valve-opening time of each injector is electrically controlled to inject a desired amount of fuel. The pressure regulator is to regulate fuel pressure in the delivery pipe to a fixed value.

Meanwhile, the injectors mounted on the delivery pipe have some variations in injection characteristics among products. To minimize errors in the fuel injection control caused by the variations of this kind, in conventional fuel injection control apparatus, injectors having a center value in the variations in injection characteristic (standard injection characteristic=“standard characteristic”) are used in conformity with an engine and the standard characteristic is reflected in calculation of a control amount by the ECU.

However, the conventional fuel injection control apparatus could not take each injection characteristic of the injectors into consideration in calculating the control amount. Even if the standard characteristic is reflected in the calculation of the control amount, therefore, an actual air-fuel ratio may be deviated from an air-fuel ratio determined at engine conformity or variations in air-fuel ratios may occur among plural cylinders. In other words, it is difficult to completely prevent the deviation between the air-fuel ratios resulting from the variations in the injection characteristics.

To solve such the inconveniences, the injectors are required to have a high-precision injection characteristic. This needs high machining accuracy and precise adjusting operations in a process of manufacturing the injectors, which would result in an increase in complexity of the injector manufacturing process.

In order to reduce the deviation of the actual air-fuel ratio from the air-fuel ratio determined at the engine conformity, the conventional apparatus is arranged such that injectors having small variations in injection characteristics are selectively mounted on the delivery pipe. Due to such the selective use, consequently, injectors having relatively large variations in injection characteristics remain unused. The manufacturing yield of injectors would decrease accordingly.

### SUMMARY OF THE INVENTION

The present invention has been made in view of the above circumstances and has an object to provide a fuel injection device and a fuel injection control apparatus capable of reducing a deviation of an actual air-fuel ratio from an air-fuel ratio determined at engine conformity and variations in air-fuel ratios among plural cylinders even if injectors which do not have high precise injection characteristics are used.

To achieve the purpose of the invention, there is provided a fuel injection device including in modular form: a delivery pipe for distributing fuel fed inside to a plurality of ports; a plurality of injectors for injecting the fuel, the injectors being fit in the ports of the delivery pipe; and characteristic storage means for individually storing an injection characteristic of each of the injectors.

According to the above structure, the individual control of the plural injectors is conducted by using the injection characteristics individually stored in the characteristic storage means in correspondence with the injectors, and correcting the control amounts to be inputted to the injectors based on the characteristics. Thus, each fuel injection amount can be controlled with desired precision and uniform fuel injection precision can be ensured among the injectors. Additionally, the delivery pipe, the plural injectors, and the characteristic storage means are modularized, so that they can be integrally controlled module-by-module, which can be used widely in different engines.

In another aspect of the present invention, there is provided a fuel injection control apparatus including: the above-mentioned fuel injection device; and a control unit provided separately from the fuel injection device, the unit including control amount calculation means for calculating a control amount based on a standard injection characteristic of each of the injectors, the control amount corresponding to an injection amount to be injected from one injector each time; wherein the calculated control amount is corrected based on the stored injection characteristic of the corresponding injector, which is controlled based on the corrected control amount to individually control the fuel injection amount from each injector.

According to the above structure, the control amount calculation means of the control unit provided separately from the modularized fuel injection device calculates the control amount corresponding to the injection amount to be injected from one injector each time based on the standard injection characteristic of the corresponding injector. The calculated control amount is corrected based on the injection characteristic stored in the characteristic storage means in relation to the injector. Each injector is thus controlled based on the corresponding corrected control amount to individually control the fuel injection amount from each injector. Consequently, in the individual control of each injector, each fuel injection amount can be controlled with desired precision. This can ensure uniform fuel injection accuracy among the injectors.

### BRIEF DESCRIPTION OF THE DRAWINGS

In the drawings,

FIG. 1 is a schematic structural view of an engine system in a first embodiment according to the present invention;

FIG. 2 is a schematic structural view of a fuel injection control apparatus in the first embodiment;

FIG. 3 is a graph showing an injection characteristic of an injector in the first embodiment;

FIG. 4 is a flowchart showing a fuel injection control program in the first embodiment;

FIG. 5 is a chart showing synchronous injection timings in a four-cylinder engine in the first embodiment;

FIG. 6 is a schematic structural view of a fuel injection control apparatus in a second embodiment according to the present invention;

FIG. 7 is a time-chart showing injector energization signals in the second embodiment;

FIG. 8 is a schematic structural view of a fuel injection control apparatus in a third embodiment according to the present invention;

FIG. 9 is a flowchart showing a process of a rising timing of an input signal in the third embodiment;

FIG. 10 is a flowchart showing a process of a falling timing of the input signal in the third embodiment; and

FIG. 11 is a schematic structural view of a fuel injection control apparatus in a fourth embodiment according to the present invention.

### DETAILED DESCRIPTION OF THE PREFERRED EMBODIMENTS

First Embodiment

A detailed description of a first preferred embodiment of a fuel injection device and a fuel injection control apparatus embodying the present invention will now be given referring to the accompanying drawings.

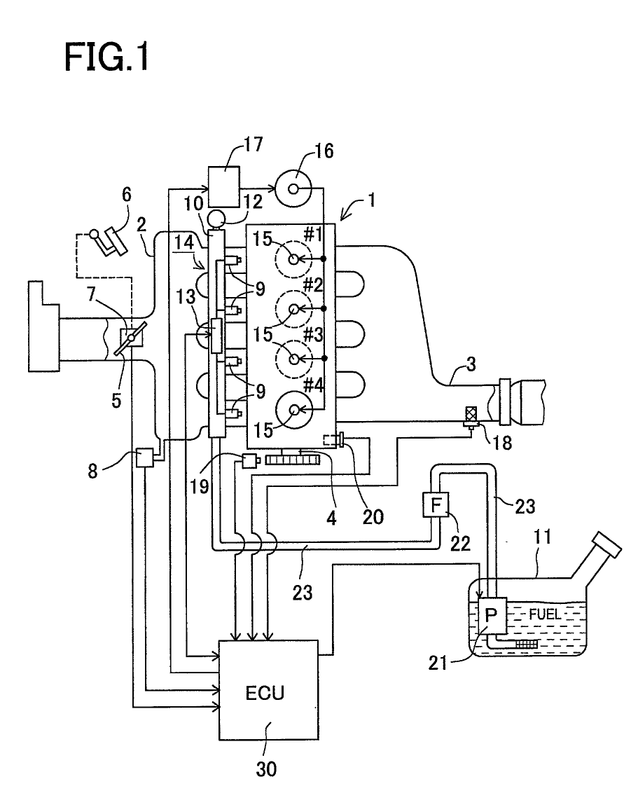

FIG. 1 is a schematic structural view of a gasoline engine system for cars, to which the fuel injection device and the fuel injection control apparatus are applied.

A multi-cylinder engine 1 having a well known structure produces driving power by exploding and burning fuel and air, namely, combustible fuel-air mixture supplied through an intake passage 2 into combustion chambers of a cylinder #1, a cylinder #2, a cylinder #3, and a cylinder #4, and discharging the burned exhaust gas through an exhaust passage 3, thereby driving a piston (not shown) to rotate a crankshaft 4.

A throttle valve 5 disposed in the intake passage 2 is caused to open and close for controlling the amount of air (intake air) which flows into the passage 2 and is taken in the combustion chambers. This valve 5 is driven in synchronization with operation of an accelerator pedal 6 provided on a driver's seat side. A throttle sensor 7 provided for the throttle valve 5 detects an opening degree (throttle opening) of the valve 5 and generates an electrical signal responsive to the detection result. An intake pressure sensor 8 disposed in the intake passage 2 detects intake pressure PM in the intake passage 2 downstream from the valve 5 and generates an electrical signal responsive to the detection result.

A plurality of injectors 9 disposed in intake ports corresponding to the cylinders #1 to #4 inject fuel into the cylinders #1 to #4 respectively. Each of the injectors 9 is a fuel injection valve containing a solenoid valve which opens at the fuel injection. The injectors 9 are fit in plural ports (not shown) of a single delivery pipe 10. This delivery pipe 10 distributes the fuel, which has been pressure-fed inside from a fuel tank 11, to the injectors 9 respectively. The delivery pipe 10 is internally provided with a pressure regulator 12 for adjusting the pressure of fuel in the pipe 10 to a constant value. Furthermore, the delivery pipe 10 is provided with an electronic circuit 13 for control of the injectors 9. This electronic circuit 13 is sealingly attached to the outer or inner face of an exterior wall of the delivery pipe 10. The injectors 9 are electrically connected to the electronic circuit 13. In the present embodiment, the plural injectors 9, the delivery pipe 10, the pressure regulator 12, and the electronic circuit 13 are modularized, forming an integral fuel injection device 14.

A plurality of spark plugs 15 are disposed in the engine 1 in correspondence to the combustion chambers and operate in response to ignition signals which are distributed from a distributor 16. This distributor 16 distributes high voltage outputted from an igniter 17 to the spark plugs 15 in synchronization with rotating angles of the crankshaft 4, namely, changes in the crank angle. The activation timing, or the ignition timing of each spark plug 15 is determined according to the output timing of the high voltage which is outputted from the igniter 17. The igniter 17 is thus controlled to control the ignition timings of the spark plugs 15.

An oxygen sensor 18 disposed in the exhaust passage 3 detects the oxygen concentration of exhaust gas discharged from the combustion chambers into the exhaust passage 3 and generates an electric signal responsive to the detection result.

A rotational speed sensor 19 disposed for the crankshaft 4 detects the rotational speed of the shaft 4, namely, an engine rotational speed NE, and produces an electrical signal responsive to the detection result. A water temperature sensor 20 provided in the engine 1 detects the temperature THW of cooling water (cooling water temp.) flowing in the engine 1 and generates an electrical signal responsive to the detection result. This cooling water temp. THW indicates a temperature condition of the engine 1.

In the present embodiment, the throttle sensor 7, the intake pressure sensor 8, the oxygen sensor 18, the rotational speed sensor 19, and the water temp. sensor 20 and others constitute operating condition detection means for detecting an operating condition of the engine 1.

In the present embodiment, a fuel supply apparatus for supplying fuel to the modularized fuel injection device 14 is constructed from the fuel tank 11, a fuel pump 21, a fuel filter 22, a fuel pipe 23, and others. The fuel tank 11 stores fuel therein. The electrically powered fuel pump 21 built in the fuel tank 11 pumps up the fuel stored in the tank 11 to discharge therefrom. The fuel pipe 23 connected to a discharge port of the fuel pump 21 is joined to the delivery pipe 10 with the fuel filter 22 disposed in the pipe 23. When the fuel pump 21 is operated, the fuel in the fuel tank 11 is discharged by the pump 21 into the fuel pipe 23, passed through the fuel filter 22 which removes foreign materials from the fuel, and then fed under pressure to the delivery pipe 10. The fuel fed into the delivery pipe 10 is distributed to the injectors 9, injected into the corresponding intake ports in association with operation of the injectors 9, then supplied to the corresponding combustion chambers.

In the present embodiment, various signals generated from the above-mentioned throttle sensor 7, intake pressure sensor 8, rotational speed sensor 19, water temp. sensor 20, and others are inputted to an electronic control unit (ECU) 30. Based on the input signals, the ECU 30 controls the injectors 9 and the igniter 7 individually in order to execute fuel injection control including air-fuel control, ignition timing control, and other controls.

In this description, the fuel injection control indicates controlling the amount of fuel (fuel injection amount) to be injected from each injector 9 and the injection timing thereof in response to the operating condition of the engine 1. The air-fuel ratio control means feedback-controlling the air-fuel ratio in the engine 1 based on detected values by the oxygen sensor 18 and other sensors. The ignition timing control signifies controlling the igniter 17 according to the operating condition of the engine 1 to thereby control the ignition timings at which the spark plugs 15 are turned on.

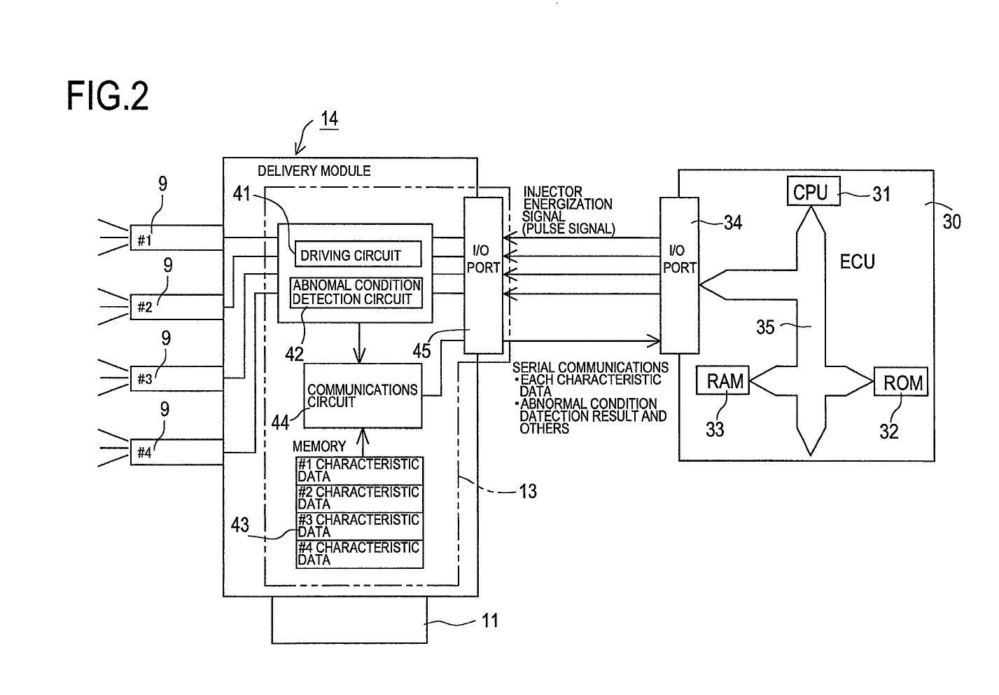

FIG. 2 is an electrical structure of the fuel injection control apparatus including the fuel injection device 14 and the ECU 30. In the present embodiment, the ECU 30 disposed separately from the fuel injection device 14 corresponds to a control unit of the present invention including control amount calculation means and control amount correction means. The ECU 30 has a well known structure which includes a central processing unit (CPU) 31, a read-only memory (ROM) 32, a random-access memory (RAM) 33, an input/output (I/O) port 34, and others, which are connected to one another via a bus 35. The ROM 32 stores previously predetermined control programs in relation to the above-mentioned various controls. The ECU 30 (CPU 31) executes the controls in accordance with the control programs.

In the present embodiment, the electronic circuit 13 of the fuel injection device 14 is provided with a driving circuit 41, an abnormal condition detection circuit 42, a nonvolantile memory 43, a communications circuit 44, and an input/output (I/O) port 45. The memory 43 stores characteristic data including each injection characteristic of the injectors 9 disposed corresponding to the cylinders #1-#4. The memory 43 corresponds to storage means of the present invention. The driving circuit 41 drives the injectors 9 individually based on the control amounts inputted from the outside. It is to be noted that the injection characteristic of each injector 9 is actually measured at manufacture. Then, after the manufactured injectors 9 are mounted on a fuel injection apparatus (in other words, before the fuel injection apparatus is shipped as a completed product), the previously measured injection characteristics of the injectors 9 are stored individually in the memory 43. The driving circuit 41 corresponds to driving means of the present invention. The abnormal condition detection circuit 42 detects abnormal conditions of the injectors 9. This circuit 42 corresponds to abnormal condition detection means of the present invention. The communications circuit 44 transmits the characteristic data stored in the memory 43 and detection results by the abnormal condition detection means 42 to the outside. The circuit 44 corresponds to transmission means of the present invention. The I/O port 45 is connected with the I/O port 34 of the ECU 30 through a predetermined wiring.

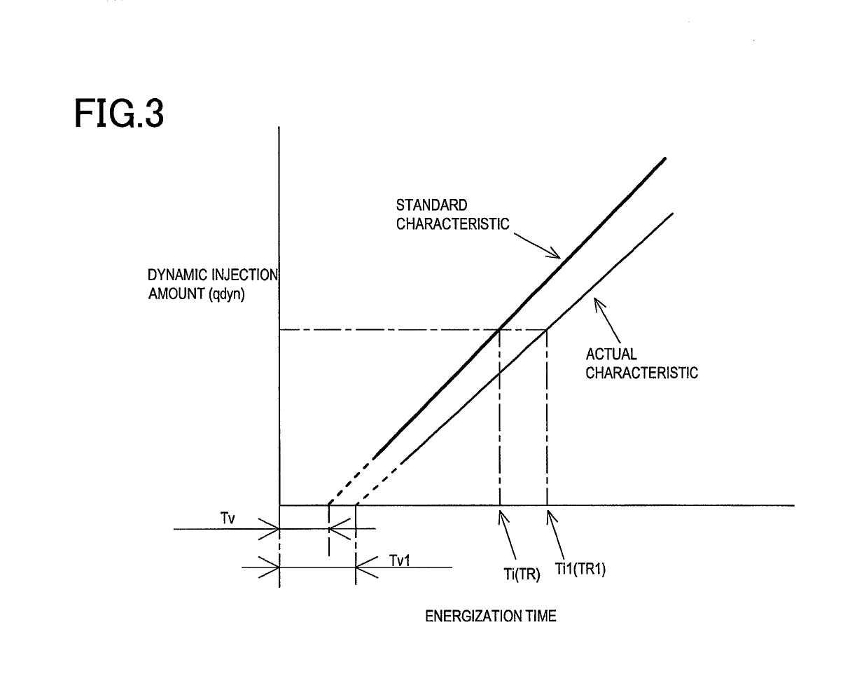

In this description, the characteristic data stored in the memory 43 includes a “cylinder number” of each injector 9 and an “injection amount characteristic” of each injector 9 corresponding to an injection characteristic. This “injection amount characteristic” is expressed by a “static injection amount Qts” and a “dynamic injection amount qts”. In general, the “injection amount characteristic” represents a “dynamic injection amount qdyn” at an “energization time Ti” to a solenoid coil of an injector. The “static injection amount Qts” is the injection amount per unit time when a valve needle of the injector is held in the maximum lift position under regular pressure, and the injection amount is expressed by the gradient in straight lines in FIG. 3. The “dynamic injection amount qdyn” means the injection amount at a certain energization time Ti. This is generally expressed as an injection amount per one stroke of the valve needle for the energization time of 2.5 ms. To be more specific, as shown in FIG. 3, within a range where the energization time Ti and the dynamic injection amount qdyn have a linear relation therebetween, the relation between the dynamic injection amount qdyn and any given time Ti is expressed by the following equation (1) from a characteristic plot in FIG. 3:

q=(Q/60)*(Ti−Tv) (1)

where “Tv” is an ineffective injection time.

The communications circuit 44 transmits the characteristic data and the abnormal condition detection results to the ECU 30 through the I/O ports by serial communication.

On the other hand, the ECU 30 serving as control amount calculation means calculates the control amount, which corresponds to the injection amount of fuel to be injected from one injector 9 each time, based on the standard injection characteristic of the injector 9. The ECU 30 serving as control amount correction means corrects the calculated control amount based on the injection amount characteristic stored in the memory 43 in correspondence to each injector 9. The ECU 30 transmits an injector energization signal (pulse signal) representative of the corrected control amount for each injector 9 to the electronic circuit 13 of the fuel injection device 14.

In the electronic circuit 13, the driving circuit 41 drives the injectors 9 individually in response to the corresponding energization signals, thereby controlling the injection amount of fuel to be injected from each injector 9.

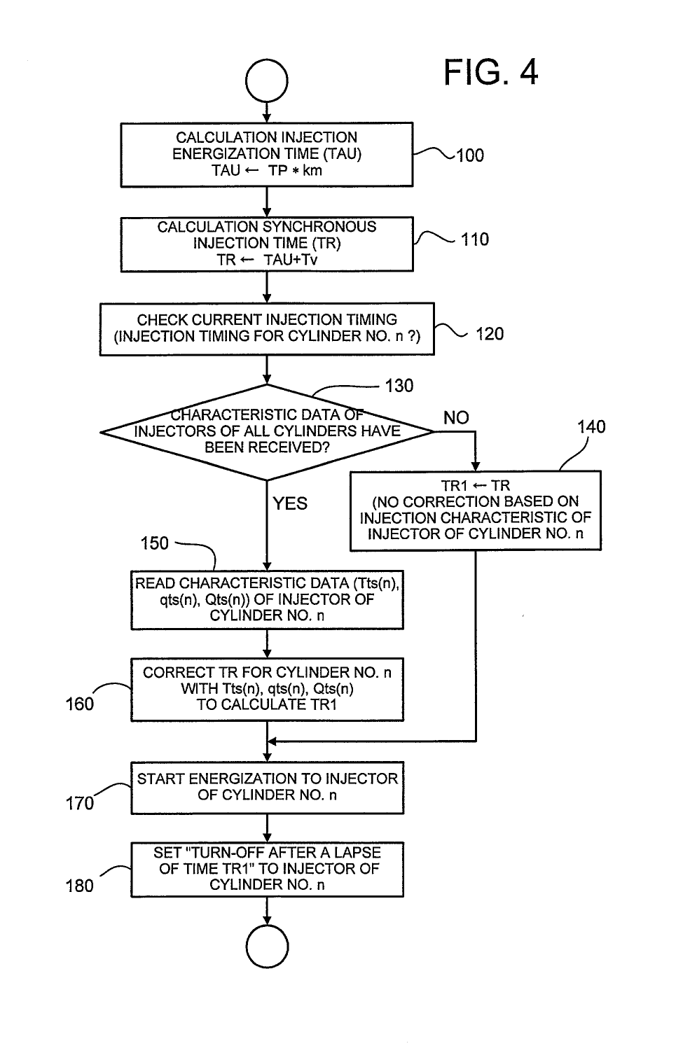

Next, the processing content of the fuel injection control which is executed by the ECU 30 is explained. FIG. 4 is a flowchart showing the content of a fuel injection control program. The ECU 30 executes this routine at each injection start timing.

In step 100, the ECU 30 calculates an injection energization time TAU, which corresponds to the injection amount of fuel to be injected from one injector 9 each time, based on the detection signals from the sensors 7, 8, and 18 to 20 and the standard injection characteristic (hereinafter, referred to as “standard characteristic”) of the injector 9. The ECU 30 calculates the injection energization time TAU by the following formula (2):

TAU←TP*Km (2)

where “TP” indicates a basic injection time which is calculated based on the detection signals from the intake pressure sensor 8 and the rotational speed sensor 19 and the standard characteristic of the injector 9, and “Km” denotes a correction efficient which is determined based on the detection signals from the throttle sensor 7, the oxygen sensor 8, and the water temp. sensor 20.

In step 110, the ECU 30 calculates a synchronous injection time TR. The ECU 30 makes this calculation of the synchronous injection time TR by the following expression (3):

TR←TAU+Tv (3)

where “Tv” denotes an ineffective injection time and “TR” means an injection time calculated based on the standard characteristic of the injector 9.

In step 120, the ECU 30 checks the current injection timing, namely, whether this injection timing is for a cylinder No. n of #1 to #4.

In step 130, the ECU 30 determines whether it has received the characteristic data on the injectors 9 of all the cylinders. In other words, the ECU 30 judges whether it has completely received the characteristic data on all the injectors 9, the data being stored in the memory 43 of the electronic circuit 13 in the fuel injection device 14 and transmitted from the communications circuit 44.

If a determination result in the step 130 is negative, the ECU 30 advances the processing to step 140. In the step 140, the ECU 30 sets the synchronous injection time TR as calculated in the step 110 to a final synchronous injection time TR1 for the cylinder No. n without correction based on the injection characteristic of the individual injectors 9, and advances the processing to step 170.

If a determination result in the step 130 is affirmative, to the contrary, the ECU 30 advances the processing to step 150. In the step 150, the ECU 30 reads the characteristic data on the injector 9 of the cylinder No. n transmitted from the fuel injection device 14, the data including a measured energization time Tts(n), a static injection amount Qts(n), and a dynamic injection amount qts(n). The transmission of the characteristic data from the electronic circuit 13 of the fuel injection device 14 to the ECU 30 may be performed at predetermined time intervals, for example, 1- or 10-second intervals. Alternatively, it may be conducted once every time the engine 1 is started.

Sequentially, in step 160, the ECU 30 corrects the synchronous injection time TR calculated in the step 110, based on the measured energization time Tts(n), the static injection amount Qts(n), and the dynamic injection amount qts(n), to determine the final synchronous injection time TR1 for the cylinder No. n.

The correction using the characteristic data in this step is executed by the ECU 30 in the following manner.

At first, the ECU 30 calculates the dynamic injection amount qdyn at the synchronous injection time TR in the standard characteristic in accordance with the following formula (4):

qdyn=(Q/60)*(TR−Tv) (4)

where “Q” is a static injection amount and “Tv” is an ineffective injection time, which are stored in advance in the ROM 32 of the ECU 30.

After that, the ECU 30 calculates an ineffective injection time Tv1 in accordance with the following equation (5):

Tv1=Tts−(60*qts)/Qts (5)

The ECU 30 calculates the final synchronous injection time TR1 in accordance with the following formula (6):

TR1=(60*qdyn)/Qts+Tv1 (6)

In the above manner, the final synchronous injection time TR1 is determined in relation to only the injector 9 of the cylinder determined as the cylinder No. n in the step 120.

In the step 170 following the step 140 or the step 160, the ECU 30 starts energization to the injector 9 of the cylinder No. n, thereby starting the valve-opening of the injector 9 of the cylinder No. n.

Then, in step 180, the ECU 30 sets “Turn-OFF of energization in the time TR1” with respect to the injector 9 of the cylinder No. n. In other words, the elapsed-time of the calculated final synchronous injection time TR1 is set as a valve-closing time of the injector 9.

The fuel injection control is executed in the above way to correct the actual characteristic with respect to the standard characteristic in FIG. 3. In the present embodiment, the above correction is performed on the ECU 30 side.

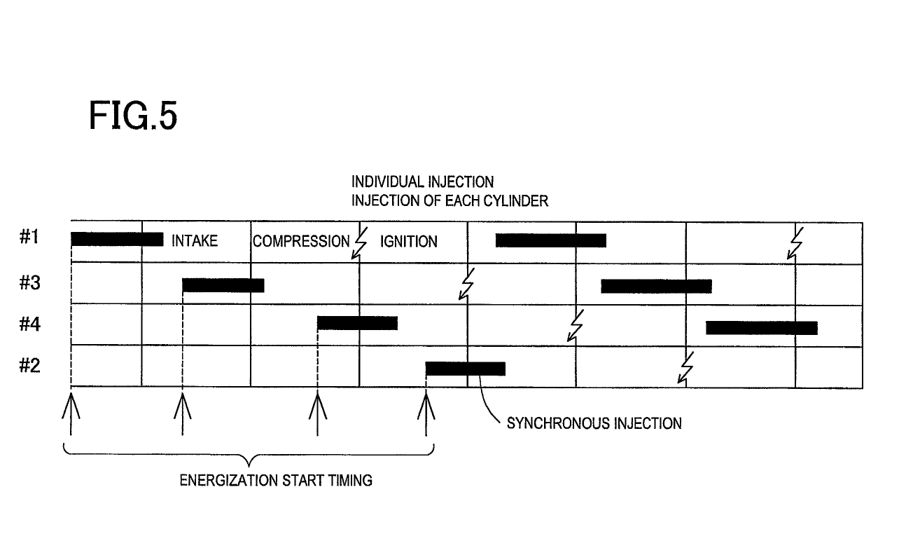

FIG. 5 shows synchronous injection timings of the four-cylinder engine. The fuel injection is performed by the injectors 9 of the cylinders #1, #3, #4 and #2 in this order. In FIG. 5, the length of each bar indicates the duration of the final synchronous injection time TR1 for each injector 9 of the cylinders #1 to #4. The starting point of each bar means the energization starting timing.

As explained above, according to the fuel injection control apparatus in the present embodiment, the ECU 30 provided separately from the modularized fuel injection device 14 calculates the synchronous injection time TR, which is equivalent to the control amount corresponding to the injection amount of fuel to be injected from one injector 9 each time, based on the standard characteristic of the injector 9. The ECU 30 corrects the calculated synchronous injection time TR based on the characteristic data stored as the injection characteristic in correspondence with each injector 9 in the memory 43 of the electronic circuit 13 in the fuel injection device 14. Based on the final synchronous injection time TR1 determined by the correction, the driving circuit 41 of the fuel injection device 14 drives the corresponding injector 9. Thus, each injection amount of fuel to be injected from each injector 9 is controlled.

Accordingly, in individual control of the plural injectors 9, each fuel injection amount can be controlled with a predetermined degree of precision. It is therefore possible to ensure uniform fuel injection accuracy among the injectors 9. As a result of this, even if injectors 9 with no high-precision injection characteristic are used, a deviation of an actual air-fuel ratio from an air-fuel ratio determined at the engine conformity and variations in air-fuel ratios among cylinders #1 to #4 can be reduced. To be more specific, even if injectors 9 having the injection characteristics with normal variations in air-fuel ratios are used, deviations and variations in the air-fuel ratios can be reduced. This can eliminate the need for manufacturing and using high-precision injectors. Alternatively, there is no need for selectively using injectors having small variations in injection characteristics and mounting them to the fuel injection device 14. Consequently, injectors having relatively large variations in injection characteristics can be used in the fuel injection device 14, so that the production yields of injectors can be enhanced.

According to the fuel injection device 14 in the first embodiment, the delivery pipe 10, the plural injectors 9, the electronic circuit 13 including the driving circuit 41 and the memory 43 and others are modularized, which can be integrally controlled module-by-module. The device can thus be widely used in various engines 1. This can facilitate the manufacture and the maintenance works of the engines 1 as compared with the conventional cases.

According to the fuel injection device 14 in the present embodiment, the abnormal condition detection circuit 42 is provided in the electronic circuit 13, so that operations of the injectors 9 can be always monitored and their failures can be detected in real time. Accordingly, as needed, the failures of the injectors 9 are treated by for example forceful stop of the fuel pump 21, and the fuel injection control by the ECU 30 can be executed.

Second Embodiment

Next, a second embodiment of the fuel injection device and the fuel injection control apparatus according to the present invention will be explained with reference to attached drawings. It is to be noted that, in the following embodiments including this one, the same elements as those in the first embodiment are given the same reference numbers and their explanations are omitted, and different points are mainly described.

In this second embodiment, the structure of the electronic circuit of the fuel injection device 14 and the control content which is executed by the ECU 30 are different from those in the first embodiment. In particular, this embodiment differs from the first embodiment in that the correction of the control amounts in relation to the injection characteristics of the injectors 9 is performed on the part of the fuel injection device 14, not on the part of the ECU 30.

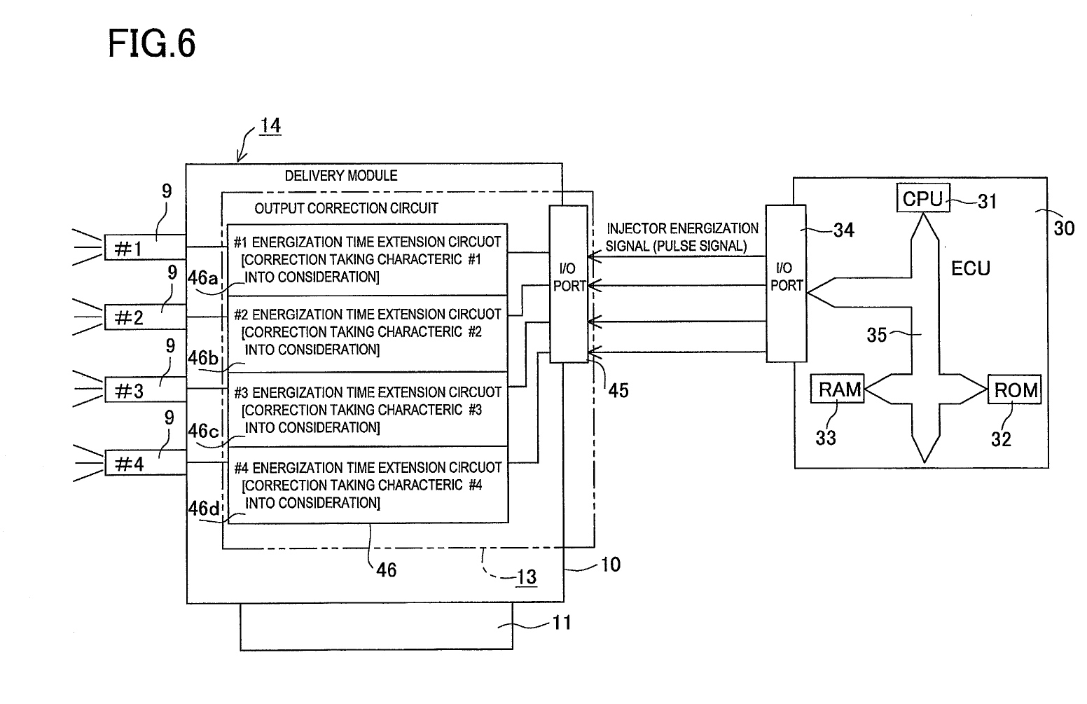

FIG. 6 shows an electrical structure of the fuel injection control apparatus including the fuel injection device 14 and the ECU 30. In the present embodiment, instead of the aforementioned driving circuit 41, abnormal condition detection circuit 42, memory 43, and communications circuit 44, the electronic circuit 13 includes the I/O port 45 and an output correction circuit 46 for the injectors 9. This output correction circuit 46 is constituted of a plurality of energization time extension circuits 46a to 46d which are provided in correspondence with the cylinders #1 to #4. The output correction circuit 46 corresponds to characteristic storage means for individually storing the injection characteristics of the injectors 9. In order to adapt the injection characteristic (actual characteristic) of each injector 9 to the standard characteristic, the corresponding energization time extension circuits 46a to 46d each convert the injection characteristic into an extension time for compensating the synchronous injection time TR, and extend the time TR by the necessary extension time. To be more specific, the energization extension circuit 46a for the cylinder #1 extends the synchronous injection time TR inputted into the circuit by a predetermined time to make correction in consideration of the injection characteristic of the injector 9 of the cylinder #1.

The energization extension circuits 46b to 46d for the cylinders #2 to #4 respectively are of the same structures as above.

In the present embodiment, on the other hand, the ECU 30 corresponds to a control unit including control amount calculation means for calculating the synchronous injection time TR as the control amount equivalent to the injection amount to be injected from one injector 9 each time, based on the standard characteristic of the injector 9. The ECU 30 in the present embodiment, different from the ECU 30 in the first embodiment, calculates the synchronous injection time TR based on the standard characteristic of each injector 9 and does not make correction of that injection time TR. The ECU 30 outputs an injector energization signal (pulse signal) representing the calculated synchronous injection time TR.

The synchronous injection time TR calculated by the ECU 30 in correspondence to each of the cylinders #1 to #4 is inputted in a form of an injector energization signal into the electronic circuit 13 of the fuel injection device 14, and inputted to the corresponding injector 9 through the output correction circuit 46 of the electronic circuit 13. Thus, each injector 9 is controlled based on the injector energization signal corresponding to the final synchronous injection amount TR1 compensated based on the injection characteristics of the injector 9, so that the individual fuel injection amount of each injector 9 is controlled.

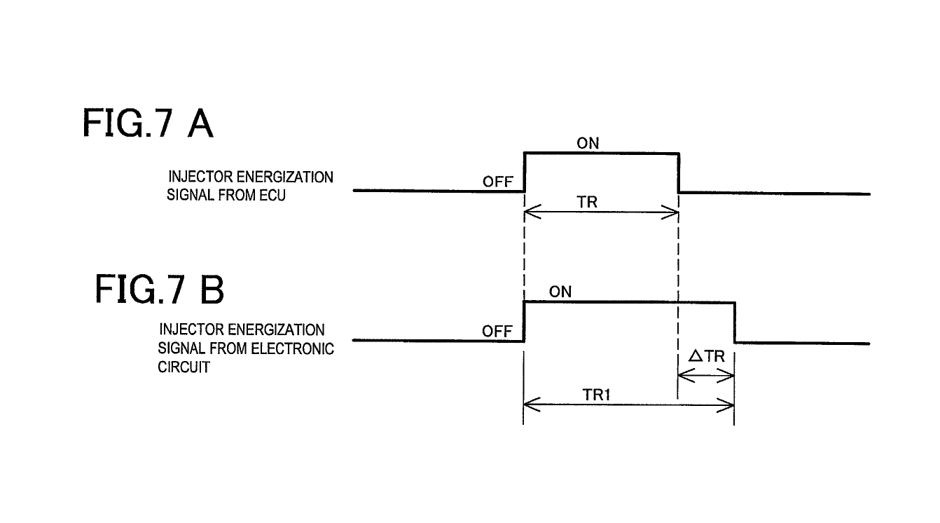

FIGS. 7(a) and (b) are time-charts each showing a relationship between an injector energization signal to be outputted from the ECU 30 to the electronic circuit 13 of the fuel injection device 14 and an injector energization signal to be outputted from the electronic circuit 13 to each injector 9. In this description, an ON pulse time of the injector energization signal from the ECU 30 corresponds to the synchronous injection time TR, and an ON pulse time of the injector energization signal from the electronic circuit 13 corresponds to the final synchronous injection time TR1. In the final synchronous injection time TR1, an increment to the synchronous injection time TR corresponds to an extension time ΔTR extended by the output correction circuit 46.

Consequently, the fuel injection control apparatus in the present embodiment can provide the same action and effect as the fuel injection control apparatus in the first embodiment. Also, the fuel injection device 14 in the present embodiment can provide the same action and effect as the fuel injection device 14 in the first embodiment.

Third Embodiment

Next, a third embodiment of the fuel injection device and the fuel injection control apparatus according to the present invention will be explained below with referenced to attached drawings.

The present embodiment differs from the second embodiment in the structure of the electronic circuit 13 of the fuel injection device 14. The ECU 30 is of the same construction as in the second embodiment. In the present embodiment, similarly, the correction of the control amount related to each injection characteristic of the injectors 9 is performed on the part of the fuel injection device 14, not on the part of the ECU 30.

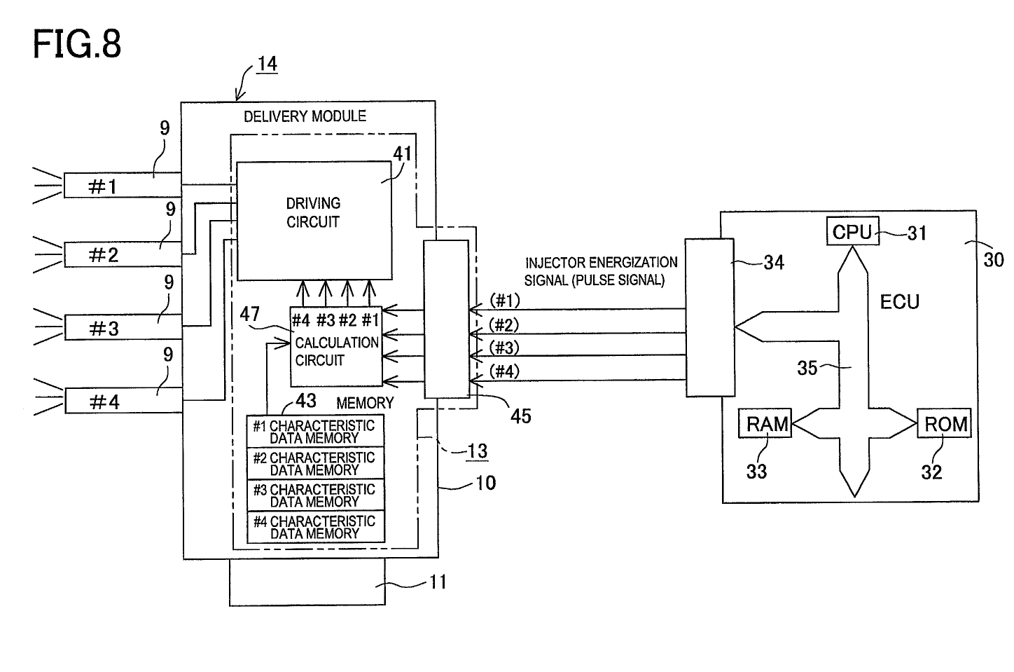

FIG. 8 shows an electrical structure of the fuel injection control apparatus including the fuel injection device 14 and the ECU 30. In the present embodiment, instead of the output correction circuit 46 described in the second embodiment, the electronic circuit 13 is constituted of the driving circuit 41, the memory 43, the calculation circuit 47, and the I/O port 45. The calculation circuit 47 is connected with the driving circuit 41, the memory 43, and I/O port 45 respectively. The driving circuit 41 is connected to each injector 9. The memory 43 individually stores the injection characteristics of the injectors 9 of the cylinders #1 to #4 as mentioned above as their respective characteristic data. The memory 43 corresponds to characteristic storage means of the present invention. The calculation circuit 47 corrects the control amount inputted from the outside based on each individual injection characteristic stored in the memory 43. The circuit 47 corresponds to control amount correction means of the present invention. The calculation circuit 47 includes a memory (not shown). The driving circuit 41 drives the injectors 9 individually based on the corresponding control amounts corrected by the calculation circuit 47. The circuit 41 corresponds to driving means of the present invention.

In the present embodiment, each synchronous injection time TR calculated by the ECU 30 in correspondence to each cylinder #1 to #4 is inputted in a form of an injector energization signal into the electronic circuit 13 of the fuel injection device 14, and taken in the calculation circuit 47. In the calculation circuit 47, each of the calculated synchronous injection times TR is corrected with reference to each injection characteristic stored in the memory 43. Based on the final synchronous injection time TR1 determined by the correction, the driving circuit 41 drives the corresponding injector 9. Thus, the injectors 9 are individually controlled based on the corresponding injector energization signals representing each individual final synchronous injection amount TR1 corrected based on the injection characteristics of the injectors 9, so that the injection amounts of fuel to be injected from the injectors 9 are individually controlled.

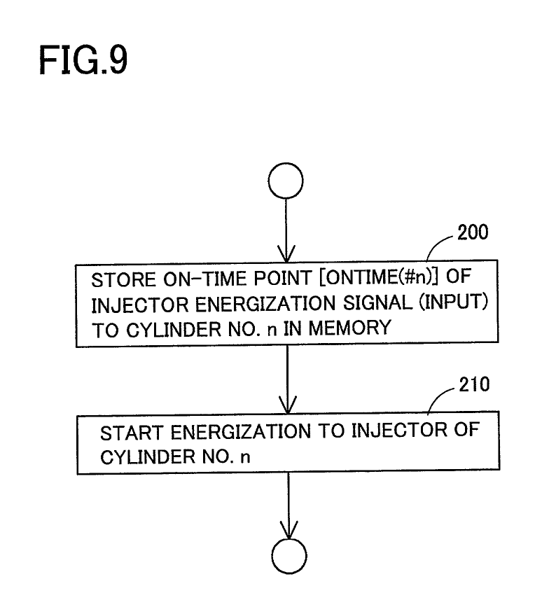

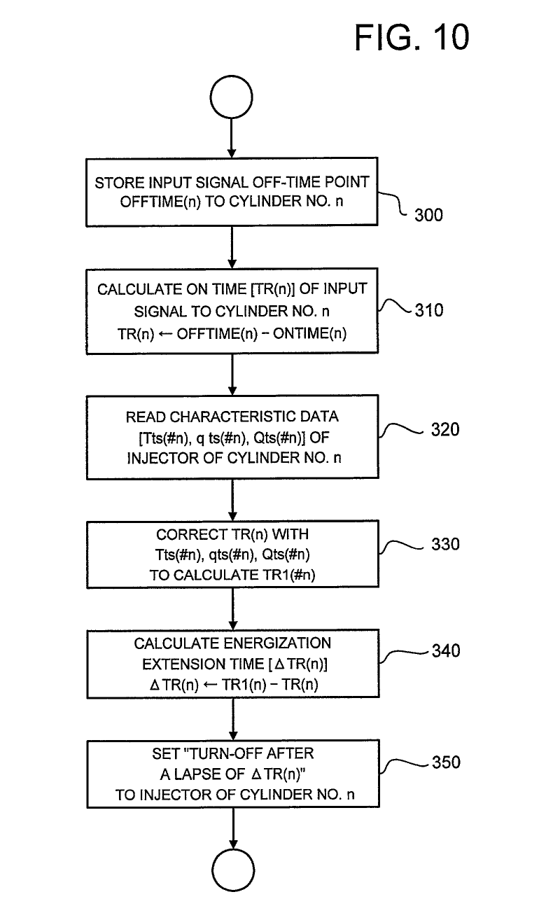

Next, explanation is made on the processing content of the fuel injection control to be executed by the calculation circuit 47 of the electronic circuit 13. FIG. 9 and FIG. 10 are flowcharts each showing the content of a program of the fuel injection control.

The flowchart in FIG. 9 shows a routine for processing the energization start of an output signal to each injector 9 of the cylinders #1 to #4. This routine is executed by the calculation circuit 47 of the electronic circuit 13 every time each injector energization signal is inputted thereto (at each energization start timing).

In step 200, the calculation circuit 47 causes its own memory to store an ON time point ONTIME(n) of the injector energization signal to the cylinder No. n. Subsequently, in step 210, the calculation circuit 47 starts energization to the injector 9 of the cylinder No. n. In otherwords, at an ON (energization start) timing of each energization signal from the ECU 30, the calculation circuit 47 starts the energization to the specific injector 9.

In this way, the calculation circuit 47 starts the energization to the injectors 9 of the cylinders #1 to #4 in turn at each ON timing of the injector energization signals from the ECU 30.

The flowchart in FIG. 10 shows a routine for processing the stop of energization of the output signal to the injectors 9 of the cylinders #1 to #4. This routine is executed by the calculation circuit 47 of the electronic circuit 13 every time each injector energization signal is inputted thereto (at each energization stop timing).

In step 300, the calculation circuit 47 stores an OFF-time point OFFTIME(n) of the input signal to the cylinder No. n in its own memory.

In step 310, sequentially, the calculation circuit 47 calculates an ON time TR(n) of the input signal to the cylinder No. n in accordance with the following formula (7):

TR(n)←OFFTIME(n)−ONTIME(n) (7)

where the ON time TR(n) for the cylinder No. n corresponds to the synchronous injection time in the standard characteristic of each injector 9, and “ONTIME(n)” is an ON-time point of the input signal stored in the memory in relation to the cylinder No. n.

In step 320, the calculation circuit 47 reads the characteristic data Tts(n), qts(n), Qts(n) of the injector 9 of the cylinder No. n from the memory 43.

In step 330, the calculation circuit 47 corrects the synchronous injection time TR(n) outputted from the ECU 30 in relation to the injector 9 of the cylinder No. n, with the use of the read characteristic data Tts(n), qts(n), Qts(n), to determine the final synchronous injection time TR1(n).

In step 340, the calculation circuit 47 calculates the energization extension time ΔTR for the injector 9 of the cylinder No. n by the following expression (8):

ΔTR(n)←TR1(n)−TR(n) (8)

In other words, the difference between the final synchronous injection time TR1(n) and the synchronous injection time TR(n) is determined as the energization extension time ΔTR.

In step 350, sequentially, the calculation circuit 47 sets “Turn-OFF of energization after a lapse of the energization extension time ΔTR” to the injector 9 of the cylinder No. n. For example, a timer of a real time output port of the calculation circuit 47 is set.

The calculation circuit 47 of the electronic circuit 13 is caused to execute the processing as above. As a result, as with the aforementioned time-chart of FIG. 7, in response to the output of the injector energization signal representing the synchronous injection time TR from the ECU 30, the electronic circuit 13 outputs the injector energization signal representing the final synchronous injection time TR1 extended by the energization extension time ΔTR.

Accordingly, the fuel injection control apparatus in the present embodiment can provide the same action and effect as the fuel injection control apparatus in the first embodiment. Additionally, the fuel injection device 14 in the present embodiment can provide the same action and effect as the fuel injection device 14 in the first embodiment.

Fourth Embodiment

Next, a fourth embodiment of the fuel injection device and the fuel injection control apparatus according to the present invention will be explained with reference to attached drawings.

The present embodiment differs from the third embodiment in the structures of the electronic circuit 13 of the fuel injection device 14 and the ECU 30. In this embodiment, the control amount related to the injection characteristic of each injector 9 is corrected on the part of the fuel injection device 14, not on the part of the ECU 30.

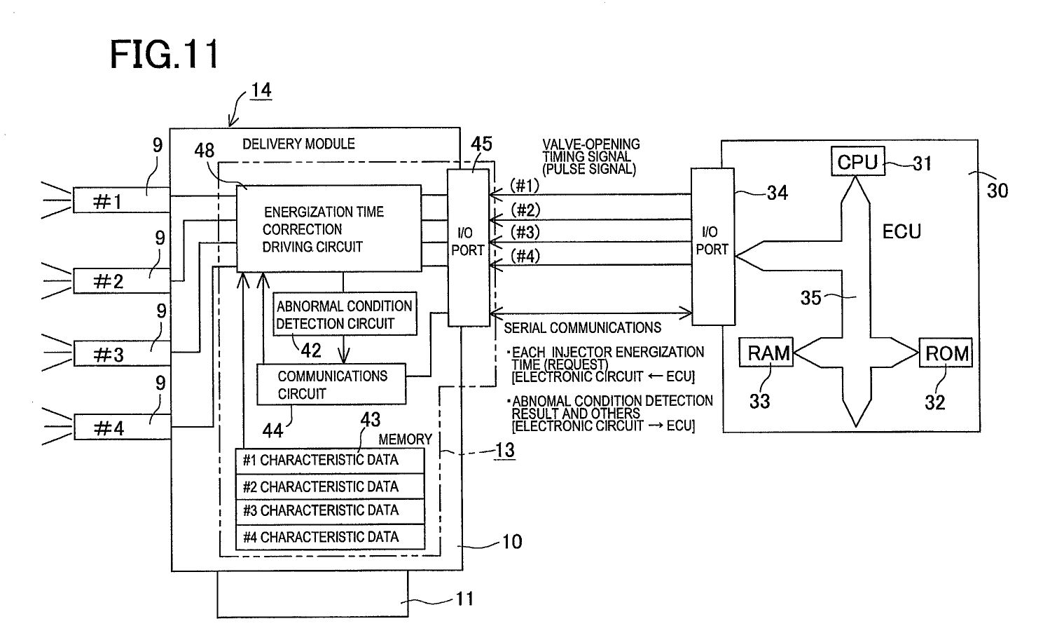

FIG. 11 shows an electrical structure of the fuel injection control apparatus including the fuel injection device 14 and the ECU 30. The electronic circuit 13 in the present embodiment, different from that in the third embodiment, is constructed of the abnormal condition detection circuit 42, a driving circuit 48 for correcting energization time, the memory 43, the communications circuit 44, and the I/O port 45. The communications circuit 44 is connected with the driving circuit 48, the abnormal condition detection circuit 42, and the I/O port 45. The energization time correction driving circuit 48 is connected with the memory 43, the communications circuit 44, the abnormal condition detection circuit 42, the I/O port 45, and the injectors 9 respectively. The memory 43 individually stores the injection characteristic of each injector 9 of the cylinders #1 to #4 as the their characteristic data in the same manner as above. The memory 43 corresponds to characteristic storage means of the present invention. The energization correction driving circuit 48 corrects the control amount inputted from the outside based on the injection characteristic stored in the memory 43. The circuit 48 corresponds to control amount correction means of the present invention. In addition, the energization correction driving circuit 48 drives the injectors 9 individually based on the respective control amounts corrected as above, corresponding to driving means of the present invention. The communications circuit 44 functions to allows exchange of an energization time (request) for each injector 9, an abnormal condition detection result, and other data by serial communications between the driving circuit 48 and the abnormal condition detection circuit 42 and the ECU 30. The circuit 44 corresponds to communication means of the present invention.

In the present embodiment, the synchronous injection time TR calculated by the ECU 30 in correspondence to each of the cylinders #1 to #4 is inputted in a form of the energization time for each injector 9 into the electronic circuit 13 of the fuel injection device 14 by serial communications, and taken in the energization time correction driving circuit 48. In this circuit 48, the taken energization time for each injector 9 is corrected with reference to the injection characteristic of each injector 9 stored in the memory 43, and the final synchronous injection time TR1 is thus calculated. Based on the final synchronous injection time TR1 obtained by the correction, the driving circuit 48 drives the corresponding injector 9. The energization to each injector 9 is started in synchronization with each valve-opening timing signal. Thus, the injectors 9 are controlled individually based on each final synchronous injection amount TR1 corrected based on the injection characteristic of each injector 9 to individually control the fuel injection amount of each injector 9.

Consequently, the fuel injection control apparatus including the present embodiment can provide the same action and effect as the fuel injection control apparatus in the first embodiment. In addition, the fuel injection device 14 in the present embodiment can provide the same action and effect as the fuel injection device 14 in the first embodiment.

The present invention is not limited to the above embodiments and may be embodied in other specific forms without departing from the essential characteristics thereof.

(1) In the above embodiments, the present invention is applied to the four-cylinder engine 1. It also may be materialized as another engine with the different number of cylinders.

(2) In the above embodiment, the fuel injection device 14 is shaped up having the pressure regulator 12. It also may be embodied without including a pressure regulator.

As explained above, according to the present invention, even if injectors which do not have a high-precision injection characteristic are used, a deviation of an actual air-fuel ratio from an air-fuel ratio determined at the engine conformity and variations in air-fuel ratios among the injectors can be reduced. Furthermore, the fuel injection device can be integrally controlled on an individual basis and can be used widely for various engines. Thus, the manufacture and maintenance works of the engines can be facilitated as compared with the conventional cases.

What is claimed is:

1. A fuel injection device including in modular form:
a delivery pipe for distributing fuel fed inside to a plurality of ports;
a plurality of injectors for injecting the fuel, the injectors being fit in the ports of the delivery pipe; and
characteristic storage means for individually storing an injection characteristic of each of the injectors.

2. The fuel injection device according to claim 1, wherein the injection characteristic of each injector includes static injection amount data and dynamic injection amount data.

3. The fuel injection device according to claim 1, wherein the injection characteristic of each injector is obtained by measurements and the previously obtained injection characteristic is stored in the characteristic storage means before the fuel injection device is shipped as a completed product.

4. A fuel injection control apparatus including:
the fuel injection device disclosed in claim 1; and
a control unit provided separately from the fuel injection device, the unit including control amount calculation means for calculating a control amount based on a standard injection characteristic of each of the injectors, the control amount corresponding to an injection amount to be injected from one injector each time;
wherein the calculated control amount is corrected based on the stored injection characteristic of the corresponding injector, which is controlled based on the corrected control amount to individually control the fuel injection amount from each injector.

5. A fuel injection control apparatus including:
the fuel injection device disclosed in claim 1; and
a control unit disposed separately from the fuel injection device, the unit including control amount calculation means for calculating a control amount based on a standard injection characteristic of each injector, the control amount corresponding to an injection amount to be injected from one injector each time;
wherein the calculated control amount is inputted to the corresponding injector through the characteristic storage means, and each injector is controlled based on the control amount, which is corrected based on the injection characteristic, to control the fuel injection amount from each injector.

6. A fuel injection device including in modular form:
a delivery pipe for distributing fuel fed inside to a plurality of ports;
a plurality of injectors fit in the ports of the delivery pipe, for injecting the fuel;
characteristic storage means for individually storing an injection characteristic of each of the injectors; and
driving means for driving each injector individually based on a control amount inputted from outside.

7. A fuel injection control apparatus including:
the fuel injection device disclosed in claim 6; and
a control unit provided separately from the fuel injection device, the unit including control amount calculation means for calculating a control amount based on a standard injection characteristic of each of the injectors, the control amount corresponding to an injection amount to be injected from one injector each time, and control amount correction means for correcting the calculated control amount based on the injection characteristic stored in the fuel injection device;
wherein the driving means in the fuel injection device drives the injectors individually based on the respective control amount corrected in the control unit to individually control the fuel injection amount from each injector.

8. A fuel injection device including in modular form:
a delivery pipe for distributing fuel fed inside to a plurality of ports;
a plurality of injectors for injecting the fuel, the injectors being fit in the ports of the delivery pipe respectively;
control amount correction means for correcting a control amount inputted from outside based on the stored injection characteristic; and
driving means for driving each injector individually based on the corrected control amount.

9. A fuel injection control apparatus including:
the fuel injection device disclosed in claim 8; and
a control unit disposed separately from the fuel injection device, the unit including control amount calculation means for calculating a control amount based on a standard injection characteristic of each injector, the control amount corresponding to an injection amount to be injected from one injector each time;
wherein the control amount calculated in the control unit is corrected by the control amount correction means based on the injection characteristic stored in the characteristic storage means in the fuel injection device, and the driving means drives each injector individually based on the corrected control amount to individually control the fuel injection amount from each injector.
